(19) United States
(12) Patent Application Publication
(10) Pub. No.: US 2019/0195641 A1
(43) Pub. Date: Jun. 27, 2019

(54) ELECTRONIC DEVICE FOR PROVIDING OPERATION INFORMATION OF VEHICLE AND METHOD FOR THE SAME

(71) Applicant: Samsung Electronics Co., Ltd., Gyeonggi-do (KR)

(72) Inventors: Jungmin KIM, Gyeonggi-do (KR); Taeho KWON, Gyeonggi-do (KR); Seongyeol PARK, Seoul (KR); Jinwoo JEON, Gyeonggi-do (KR); Youngbin CHO, Gyeonggi-do (KR); Doosuk KANG, Gyeonggi-do (KR); Gajin SONG, Gyeonggi-do (KR)

(21) Appl. No.: 16/159,896

(22) Filed: Oct. 15, 2018

(30) Foreign Application Priority Data
Dec. 27, 2017 (KR) 10-2017-0180865

(51) Int. Cl. G01C 21/34; G01C 21/36; H04W 4/024; B60W 50/14; G06F 17/30; G08G 1/01

(52) U.S. Cl. CPC G01C 21/3415; G01C 21/3694; H04W 4/024; B60W 50/14; G01S 19/45; G06F 17/30554; G08G 1/0133; B60W 2050/146; G06F 17/30528

(57) ABSTRACT

The present disclosure relates to an electronic device and method for a vehicle. The electronic devices includes a wireless communication circuit, at least one processor operatively coupled to the wireless communication circuit, a sensor, and a memory operatively coupled to the at least one processor. The processor implements the method, including detecting by the sensor whether the vehicle arrives at a destination location, when the vehicle arrives at the destination location, transmitting to the vehicle a request for operation data of the vehicle, after receiving the operation data from the vehicle, detecting based on the received operation data whether the vehicle is deactivated, and transmitting at least a part of the data to an external server using the wireless communication circuit.

### CROSS-REFERENCE TO RELATED APPLICATION(S)

This application is based on and claims priority under 35 U.S.C. § 119 to Korean Patent Application No. 10-2017-0180865, filed on Dec. 27, 2017, in the Korean Intellectual Property Office, the disclosure of which is incorporated by reference herein in its entirety.

### TECHNICAL FIELD

Various embodiments of the present disclosure relate to an electronic device for providing operation information of various transportation vehicles including a motor vehicle, etc. and method for the same.

### BACKGROUND

Internet-of-Things (IoT) technology refers to technology for allowing various devices equipped with sensors and communication functions built therein to be connected with each other through a network. As IoT has become popular, technologies have been developing to allow various devices to be connected and exchange information with each other through a network.

In recent years, the IoT technology has been also applied to transportation vehicles, for example, motor vehicles. In a connected car field, various technologies for data-collect and control of a motor vehicle have been developed and popularized.

To be specific, a connected car is a technology for providing a more convenient operation environment by convergence of the vehicle with a function of a mobile communication terminal (e.g., a smart phone). The connected car may provide a user with various information using a method by which various sensors and measuring devices installed in the vehicle may perform communication with a user's mobile terminal or an external server.

### SUMMARY

A recent transportation vehicle or mobile terminal may provide a navigation service that provides navigation to a destination using an internal/external navigation or a navigation application. When a user operating the vehicle or a user using a mobile terminal sets a destination, the navigation service may guide an optimal route from a current location to the destination. The navigation service may be terminated when the vehicle or the user approaches the destination within a certain distance or arrives at the destination.

However, even when the vehicle or the user arrives at the destination, it may take a more considerable time to enter a parking lot located at the destination and then to complete the parking after entering the parking lot. Furthermore, it may take far more time when the destination is congested due to many vehicles entering the destination or a number of visitors and vehicles already arrived at the destination.

However, since the existing navigation service is terminated after the vehicle arrives at the destination or approaches the destination within a certain distance, the service does not provide information on required time changeable depending on a destination situation.

An object of the present disclosure is directed to an electronic device in communication with a vehicle. The electronic device includes a wireless communication circuit, at least one processor operatively coupled to the wireless communication circuit, a memory operatively coupled to the at least one processor, wherein the memory stores instructions executable by the at least one processor to cause the electronic device to detect whether the vehicle arrives at a destination location, when the vehicle arrives at the destination location, transmit to the vehicle a request for operation data of the vehicle, after receiving the operation data from the vehicle, detected based on the received operation data whether the vehicle is deactivated, and transmit at least a part of the data to an external server using the wireless communication circuit.

Another object of the present disclosure is directed to a method in an electronic device communicatively coupled to a vehicle, including detecting by a sensor whether the vehicle arrives at a destination location, when the vehicle arrives at the destination location, transmitting to the vehicle a request for operation data of the vehicle, after receiving the operation data from the vehicle, detecting based on the received operation data whether the vehicle is deactivated, and transmitting at least a part of the data to an external server using a wireless communication circuit.

Objects of the present disclosure are not limited to the above-mentioned objects. That is, other objects that are not mentioned may be obviously understood by those skilled in the art to which the present disclosure pertains from the following description.

Various embodiments of the present disclosure are directed to the provision of an electronic device for providing operation information of a vehicle and a method for the same capable of providing various functions using the vehicle operation data by collecting operation data until a start of the vehicle is off in response to detecting that the vehicle arrives at a destination.

Various embodiments of the present disclosure are directed to the provision of an electronic device for providing operation information of a vehicle and a method for the same capable of providing information related to the destination set by a user by using operation data until a start of the vehicle is off in response to detecting that the vehicle arrives at a destination.

Various embodiments of the present disclosure are directed to the provision of an electronic device for providing operation information of a vehicle and a method for the same capable of providing information on time required to complete a parking after the vehicle arrives at the destination by generating and providing data related to a destination based on operation data.

Various embodiments of the present disclosure are directed to the provision of an electronic device for providing operation information of a vehicle and a method for the same capable of providing a user with congestion information of the destination after the vehicle arrives at the destination by generating and providing data related to a destination based on operation data.

The effects that may be achieved by the embodiments of the present disclosure are not limited to the above-mentioned objects. That is, other effects that are not mentioned may be obviously understood by those skilled in the art to which the present disclosure pertains from the following description.

### BRIEF DESCRIPTION OF THE DRAWINGS

FIG. 1 is a block diagram illustrating an electronic device according to various embodiments of the present disclosure.

FIG. 2 is a block diagram illustrating a program according to various embodiments.

FIG. 3 is a diagram illustrating relations among an electronic device, an external server, a mobile terminal, and a vehicle according to various embodiments of the present disclosure.

FIG. 4 is a block diagram illustrating an electronic device according to various embodiments of the present disclosure.

FIG. 5A and FIG. 5B are diagrams each illustrating an embodiment of information related to a destination in an electronic device according to various embodiments of the present disclosure.

FIG. 6A is an operational flowchart illustrating relations among an electronic device, an external server, and a vehicle with regard to a method for operating the electronic device according to various embodiments of the present disclosure.

FIG. 6B is an operational flowchart illustrating relations among an electronic device, a mobile terminal, an external server, and a vehicle with regard to a method for operating the electronic device according to various embodiments of the present disclosure.

FIG. 7 is an operational flowchart illustrating a method for operating an electronic device according to various embodiments of the present disclosure.

FIG. 8 is an operational flowchart illustrating a method for operating an electronic device according to another embodiment of the present disclosure.

### DETAILED DESCRIPTION

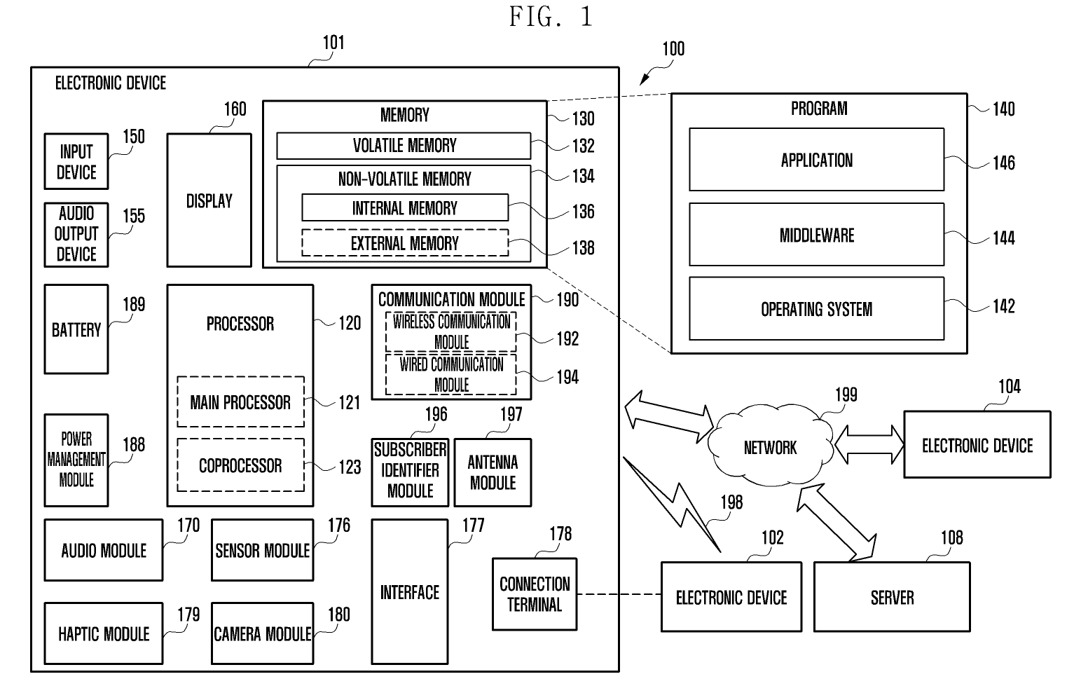

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 or “coprocessor” (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

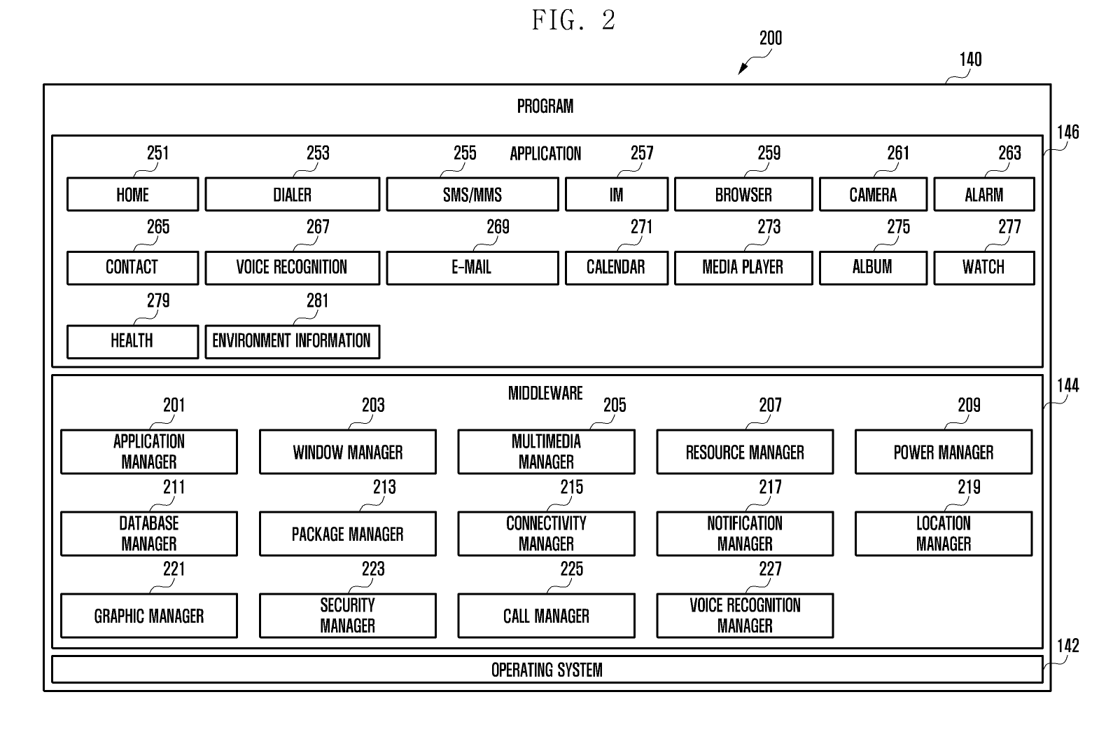

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony or call manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email application 269, calendar 271, media player 273, album 275, watch or clock 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

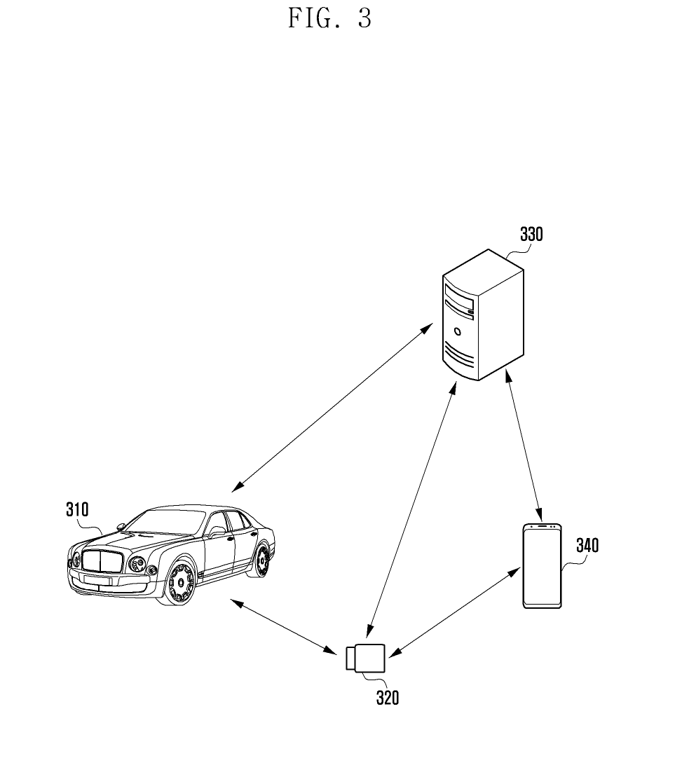

FIG. 3 is a diagram illustrating relations among an electronic device, an external server, a mobile terminal, and a vehicle according to various embodiments of the present disclosure.

A vehicle 310 may refer to any vehicle capable of transporting various objects such as people, stuffs, and the like. According to various embodiments of the present disclosure, the vehicle 310 may be electrically connected to at least one of an electronic device 320, an external server 330 and a mobile terminal 340 using various communication means (e.g., wireless fidelity “wi-fi”, BlueTooth, NFC, etc.). The vehicle 310 may include a separate electronic device (e.g., a navigational unit) that provides a navigation service generating route guidance towards a destination.

According to various embodiments of the present disclosure, the vehicle 310 may refer to any of a variety of vehicles having power generated by using a motor or an engine, such as a motorcycle, etc. as well as a passenger car, a bus, and a truck.

According to various embodiments of the present disclosure, an electronic device (e.g., 320) may be electrically connected to the vehicle 310. The phrase ‘electrically connected’, may include both cases in which the electronic device 320 and the vehicle 310 are connected with each other using a wireless standard, and the electronic device 320 and the vehicle 310 are wired and connected with each other using a separate standard.

According to various embodiments of the present disclosure, the electronic device 320 may be electrically connected with the vehicle 310 using a connector, the standard of which is compatible with an on board diagnostic (OBD) standard, a separate communication standard used by the vehicle 310.

According to various embodiments of the present disclosure, the electronic device 320 may receive various information from the vehicle 310. For example, the electronic device 320 may receive various information on the vehicle 310 from the vehicle 310 through a unified diagnostic service (UDS) available in the OBD standard.

According to various embodiments of the present disclosure, the electronic device 320 may receive operation data of the vehicle 310. Operation data of the vehicle 310 may include various information related to the vehicle 310 such as: information indicating on/off of the start of the vehicle 310, revolution per minute (RPM) information of the engine or the motor of the vehicle 310, operation information of transmission of the vehicle 310, fuel consumption and fuel remains of the vehicle 310, battery remains of the vehicle 310, fuel efficiency of the vehicle 310, and/or the like.

According to various embodiments of the present disclosure, the electronic device 320 may receive the operation data of the vehicle 310 and confirm operation information of the vehicle 310 based on the operation data. For example, the electronic device 320 may confirm whether the start of the vehicle 310 is on/off based on the operation data of the vehicle 310.

According to various embodiments of the present disclosure, whether the start of the vehicle 310 is on/off may indicate whether the engine or motor included in the vehicle 310 is on/off.

Although the electronic device 320 is illustrated as a component separate from the vehicle 310, according to various embodiments of the present disclosure, the vehicle 310 may be configured to include the electronic device 320. For example, the vehicle 310 may implement all the operations or components of the electronic device 320 described herein. Hereinafter, for convenience of description, the electronic device 320 is described as the component separate from the vehicle 310.

According to various embodiments of the present disclosure, the external server 330 may support a navigation service provided to the vehicle 310. The navigation service may include various information available for the vehicle 310 to arrive at the destination quickly and accurately. For example, the external server 330 may provide the navigation service on considering current location information of the vehicle 310, destination location information that is set by a device providing a navigation service installed in the vehicle 310 or by the mobile terminal 340, information on the real-time traffic volume, and the like.

According to various embodiments of the present disclosure, the external server 330 may respectively store account information of a user of the mobile terminal 340 and that of a user of the electronic device 320, and may also process various services requested by each user.

According to various embodiments of the present disclosure, the external server 330 may generate information related to the destination and transmit the information to the electronic device 320 based at least in part on the operation data transmitted from the electronic device 320. The information related to the destination may include congestion information based on information on the real-time traffic volume or an average traffic volume of the destination, information on an available space of a parking lot adjacent to the destination, and the like.

The mobile terminal 340 may refer to the mobile terminal 340 carried by a person on board the vehicle 310, such as a driver who operates the vehicle 310, a fellow passenger, or the like. According to various embodiments of the present disclosure, the mobile terminal 340 may provide the navigation service indicating the route to the destination, in response to a user's input through a navigation application program installed in the mobile terminal 340.

According to various embodiments of the present disclosure, the mobile terminal 340 may be electrically connected to the electronic device 320. The mobile terminal 340 may receive information related to the destination transmitted from the electronic device 320 or the external server 330. The mobile terminal 340 may display the information related to the destination received through a screen of the mobile terminal 340. For example, the mobile terminal 340 may provide the user with the navigation service using the received information related to the destination.

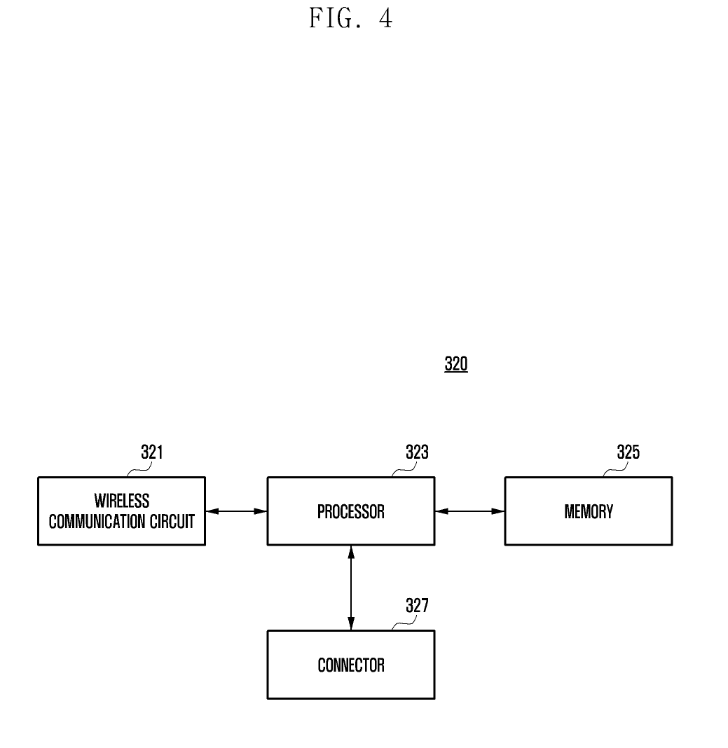

FIG. 4 is a block diagram illustrating an electronic device according to various embodiments of the present disclosure.

Referring to FIG. 4, an electronic device (e.g., the electronic device 320 in FIG. 3) according to various embodiments of the present disclosure may include a wireless communication circuit 321, a processor 323, and a memory 325.

The wireless communication circuit 321 may transmit/receive the data to/from various electronic devices (for example, the external server 330 in FIG. 3 and the mobile terminal 340 in FIG. 3) which are connected to the electronic device 320 using various wireless communication standards.

According to various embodiments of the present disclosure, the wireless communication circuit 321 may receive information related to a navigation service through the external server 330 or the mobile terminal 340 connected to the wireless communication circuit 321.

According to various embodiments of the present disclosure, the electronic device 320 may further include a connector 327 that is electrically connected to the vehicle 310. The electronic device 320 may receive various information such as the operation information of the vehicle 310, the location information of the vehicle 310, and the like from the vehicle 310 through the connector 327.

The memory 325 may be operatively connected to the processor 323 to transiently or non-transiently store instructions related to various tasks performed by the processor 323.

The processor 323 may perform various operations using the instructions stored in the memory 325.

According to various embodiments of the present disclosure, the electronic device 320 may further include a configuration related to an interface (e.g., an OBD data communication standard) which performs communication with the vehicle 310. For example, the electronic device 320 may include a microcontroller which processes the data transmitted from the vehicle 310 and transmit the data, transmitted from the vehicle 310, to the processor 323; and an embedded security element which processes a task related to securing the data transmitted/received between the vehicle 310 and the electronic device 320 each other.

According to various embodiments of the present disclosure, the processor 323 may detect that the vehicle arrives at a destination of the navigation service.

According to various embodiments of the present disclosure, when the vehicle 310 or an internal or external navigation of the vehicle 310 provides, the navigation service, the processor 323 may receive the destination information transmitted from the vehicle 310 by using the connector 327. The processor 323 may detect that the vehicle arrives at the destination of the navigation service based on a result of comparing the current location of the electronic device 320 with the location of the designated destination.

According to various embodiments of the present disclosure, when the vehicle 310, or the internal or external navigation of the vehicle 310 does not provide the navigation service, the processor 323 may detect that the vehicle arrives at the destination of the navigation service, in response to receiving data indicating the arrival of the vehicle at the destination through the connector 327 or the data indicating that the arrival of the vehicle at the destination by the wireless communication circuit 321.

According to various embodiments of the present disclosure, the processor 323 may detect that the vehicle arrives at the destination of the navigation service in response to receiving data indicating the termination of the navigation service. The navigation service may be automatically terminated when the vehicle arrives at the destination or the vehicle is adjacent to the destination. Accordingly, the processor 323 may detect that the vehicle arrives at the destination in response to receiving the data informing the termination of the navigation service.

According to various embodiments of the present disclosure, the processor 323 may confirm whether a start of the vehicle 310 is off, in response to detecting that the vehicle arrives at the destination. Even when the vehicle 310 arrives at the destination, there may be a situation where the operation must be continued since a parking is not possible due to the congested destination, insufficient parking space, and the like. At this time, the processor 323 may request the vehicle 310 for the operation data of the vehicle 310 in response to detecting that the vehicle arrives at the destination.

According to another embodiment of the present disclosure, the processor 323 may request the operation data of the vehicle 310 in response to detecting that the position of the electronic device 320 corresponds to a specific location. For example, the processor 323 may request the operation data of the vehicle 310 in response to detecting that the vehicle arrives at a predetermined specific location (e.g., a supermarket, a department store, a coffee shop, etc.). According to various embodiments of the present disclosure, the processor 323 may transmit at least a part of the operation data to an external server, in response to the position of the electronic device 320 arriving at the predetermined location.

According to various embodiments of the present disclosure, the processor 323 may also request the operation data of the vehicle 310 based on the data transmitted from the mobile terminal 340. For example, the processor 323 may request the operation data of the vehicle 310 in response to receiving data, etc. indicating that a settlement using a credit card is completed at the specific place determined in advance from the mobile terminal 340.

The processor 323 may receive the operation data of the vehicle 310. The operation data of the vehicle 310 may be transmitted to the processor 323 through the connector 327. The processor 323 may receive the operation data of the vehicle 310 using various wireless communication means that may be connected to the vehicle 310 when the electronic device 320 does not include the connector 327.

According to various embodiments of the present disclosure, the operation data of the vehicle 310 may include various information on the operations of various components included in the vehicle 310 as follows: information related to navigation service; information indicating whether a passenger aboard the vehicle 310 is wearing a seat belt when the vehicle 310 includes the seat belt; information indicating whether the door included in the vehicle 310 is opened or closed; information indicating on/off of the start of the vehicle 310; operation information of the air circulation device of the vehicle 310; voltage information supplied from the battery of the vehicle 310; RPM information of the engine of the vehicle 310; and operation information of the transmission of the vehicle 310. The operation data of the vehicle 310 may further include various information which may be related to the operation of the vehicle 310 such as the fuel consumption, fuel remains, etc. of the vehicle 310.

According to various embodiments of the present disclosure, a data standard which the processor 323 transmits/receives to/from the vehicle 310 through the connector may refer to the data standard which may be supported by the vehicle 310.

For example, the data which the processor 323 transmits/receives to/from the vehicle 310 through the connector 327 may be defined as shown in Table 1 below.

TABLE 1

| | | Information | |
|---|---|---|---|
| Division | Instruction | (Example) | Interpretation |
| DEVI | DEID 01 | 00, 10, 8, LAST | Factor 1 (00): Sequence number |
| (Request | | TRIP | Factor 2 (10): Service identifier |
| message) | | | Factor 3: Data length |
| | | | Factor 4: Data (last trip: previous |
| | | | operation information) |
| OBD | DEID 11 | 00, 10, 26, | Factor 1: Sequence Number (hexadecimal |
| (Reply | | 20120311111205, | number: 00) |
| message | | 20120311111114 | Factor 2: Service identifier |
| upon | | 21, 12, 2300 | Factor 3: Data length(HEX) |
| successful | | | Factor 4: Start on time → |
| request) | | | Mar. 11, 2012 11:12:05 AM |
| | | | Start off time → |
| | | | Mar. 11, 2012 11:14:21 AM |
| | | | ※ month (2)/day (2)/year (4)/hour (2)/ |
| | | | minute (2)/second (2) (digit) |
| | | | Maximum speed→ 125 Km/h (display |
| | | | range: 0~255) <decimal number> |
| | | | Drive distance → 2.3 Km (display range: |
| | | | 0~4,294,967,295 m) <decimal number>, |
| | | | used as a delimiter |
| | | | * notation: failed to obtain |
| | | | corresponding data from trip |
| | | | information. |
| OBD | | 00, 100 | Factor 2: 100 message formatting error |
| (Reply | | | 101 message reception failure |
| message | | | 105 Undefined error |
| upon failed | | | 100 Read failure, 101 Write failure |
| request) | | | 102 Not supported |
| | | | 105 Parameter not supported |
| | | | 501 No reply |
| | | | 502 ECU End of communication |

Table 1 described above is an embodiment of the data standard which is transmitted/received between the electronic device 320 including the processor 323 and the vehicle 310 each other, and the electronic device 320 may transmit/receive data to/from the vehicle 310 each other with a data standard different from that of Table 1. According to various embodiments of the present disclosure, the processor 323 may determine whether the vehicle 310 is operating using the operation data of the vehicle 310.

For example, the processor 323 may confirm the RPM information of the engine included in the operation data of the vehicle 310, and determine whether the vehicle 310 is operating based on the RPM information of the engine. When the vehicle 310 terminates the operation, since the start of the engine is off, the RPM may be confirmed to be zero. When the vehicle 310 continues the operation, since the start of the engine is on, the RPM may be confirmed to be other than zero.

For another example, the processor 323 may determine whether the vehicle 310 is operating by using information indicating whether the door of the vehicle 310 is opened or closed, information indicating whether the passenger is wearing a seat belt, and the like. The processor 323 may detect that the seat belt is released or the door is opened just before the operation of the vehicle 310 is terminated. By using this, the processor 323 may determine whether the vehicle 310 is operating.

For another example, the processor 323 may confirm the operation information of the transmission of the vehicle 310 and determine whether the vehicle 310 is operating based on the operation information of the transmission. In order to park the vehicle 310 before the operation of the vehicle 310 is terminated, a user may control the transmission by using a shift lever of the vehicle 310 (for example, the user may park the vehicle by setting the shift lever to P, and operate the shift lever (repetition of D, N and R) for parking). The processor 323 may determine whether the operation of the vehicle 310 is terminated based on the operation information of the transmission.

For another example, the processor 323 may confirm speed information of the vehicle 310, location information of the vehicle 310, and the like, and determines whether the vehicle 310 is operating based on the confirmed information.

The processor 323 may transmit the operation data of the vehicle 310 to the external server 330 in response to the determination that the vehicle 310 is operating. According to various embodiments of the present disclosure, the processor 323 may continuously request and receive the operation data of the vehicle 310 until receiving information indicating the operation of the vehicle 310 is terminated, and then transmit the operation data of the vehicle 310 to the external server 330. The operation data transmitted to the external server 330 may include the time information when the vehicle 310 arrives at the destination and the time information when the start of the engine of the vehicle 310 is off. According to various embodiments of the present disclosure, the external server 330 may generate the congestion information of the destination based on the time information of arrival of the vehicle at the destination and the time information when the start of the engine of the vehicle 310 is off. The difference between the time of arrival of the vehicle at the destination and the time at which the start of the engine is off may have a correlation with the congestion of the destination. For example, the higher the congestion degree of the destination, the greater the difference between the time of the arrival of the vehicle at the destination and the time at which the start of the engine is off (which may be considered as the time the actual parking is completed).

According to various embodiments of the present disclosure, the processor 323 may transmit information collected by various sensors (e.g., an air pressure sensor, a GPS sensor, etc.) installed in the electronic device 320 to the external server 330 together with the operation data of the vehicle 310. For example, when the electronic device 320 includes an air pressure sensor, the electronic device 320 may confirm that an altitude at which the vehicle 310 is currently located or a floor on which the vehicle 310 is currently located based on the data transmitted from the air pressure sensor. The collected information that the electronic device 320 transmits to the external server 330 may be used to generate information related to the destination together with the operation data of the vehicle 310.

According to various embodiments of the present disclosure, the processor 323 may receive the congestion information of the destination generated by the external server 330 using the wireless communication circuit 321, and provide the information including the congestion information of the destination, and the like as information related to the destination.

According to various embodiments of the present disclosure, the processor 323 may confirm the distance between the current location of the electronic device 320 and the destination. The processor 323 may use the location information collected by a location sensor (e.g., a GPS sensor, etc.), which is additionally included in the electronic device 320, and destination location information to determine whether the vehicle is adjacent to the destination. In response to the determining that the vehicle is adjacent to the destination, processor 323 may request the external server 330 for information related to the destination and receive the information from the server 330 and then, may provide the information related to the destination.

According to various embodiments of the present disclosure, the processor 323 may confirm whether the start of the vehicle 310 is off. In response to confirming that the start of the vehicle 310 is not off and in an on state, the processor 323 may confirm whether the navigation service, provided by the vehicle 310 or the mobile terminal 340, is terminated.

According to various embodiments of the present disclosure, processor 323 may confirm that the navigation service is terminated. In response to confirming that the navigation service is terminated, the processor 323 may request the external server 330 for information related to the destination and receive the information from the server 330 and then, may provide the information related to the destination.

According to various embodiments of the present disclosure, the processor 323 may receive information indicating the arrival of the vehicle at the destination from the vehicle 310 or the mobile terminal 340. In response to receiving information indicating the arrival of the vehicle at the destination, the processor 323 may request the external server 330 for information related to the destination and receive the information from the server 330 and then, may provide the information related to the destination.

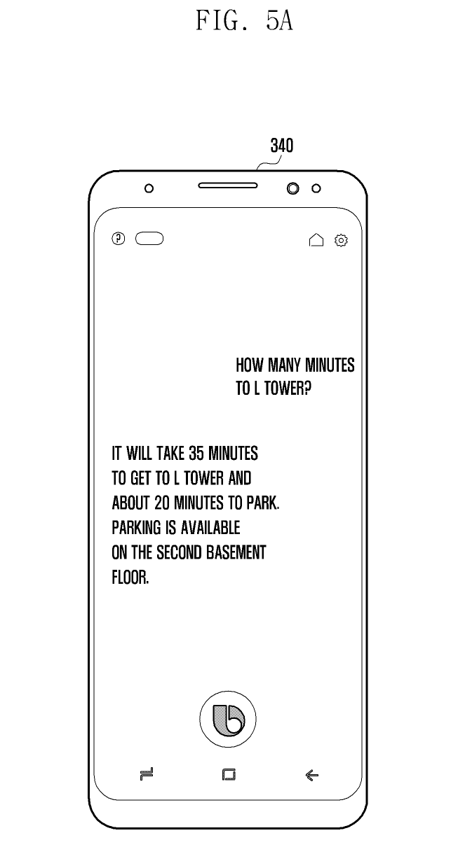

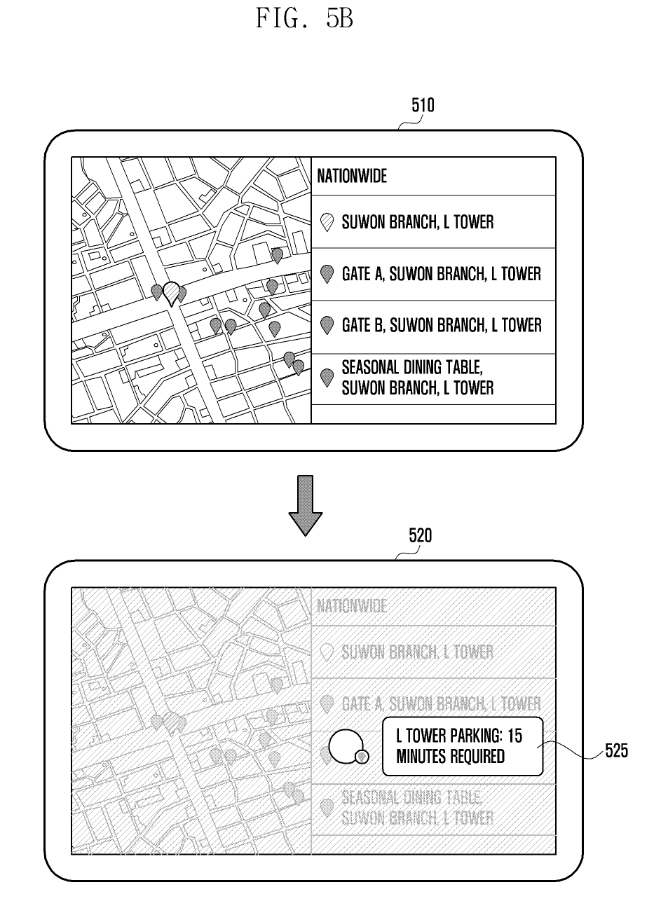

According to various embodiments of the present disclosure, the processor 323 may provide the information related to destination by transmitting information related to the destination to the vehicle 310 capable of providing a navigation service or the mobile terminal 340 capable of providing a navigation service, and by controlling a display or a speaker, installed in the vehicle 310 or the mobile terminal 340, to output the information related to the destination. Specific examples providing the information related to the destination are shown in FIGS. 5A and 5B.

According to various embodiments of the present disclosure, the electronic device 320 may include a separate battery, and in this case, the power required for the operation of the electronic device 320 may be supplied by the separate battery. In a case where the electronic device 320 does not have a battery therein, the battery of the vehicle 310 electrically connected to the electronic device 320 may supply the power required for the operation of the electronic device 320.

FIGS. 5A and 5B are diagrams each illustrating embodiment of information related to a destination in an electronic device according to various embodiments of the present disclosure.

According to various embodiments of the present disclosure, an electronic device (e.g., the electronic device 320 in FIG. 3) may request an external server (e.g., the external server 330 in FIG. 3) for information related to a destination, and may receive information related to the destination from the external server 330.

According to various embodiments of the disclosure, the information related to the destination may include congestion information based on the traffic volume of the destination, information indicating the available space of parking lot adjacent to the destination, and the like. The external server 330 may generate and transmit the information related to the destination using the operation data of the vehicle 310 transmitted by various electronic devices, which are connected to the external server 330 including the electronic device 320, and the sensor data transmitted by the electronic device 320.

According to various embodiments of the present disclosure, the external server 330 may transmit information related to the destination to the electronic device 320. The electronic device 320 may transmit information related to a destination to a vehicle (e.g., the vehicle 310 in FIG. 3) electrically connected to the electronic device 320, and control the vehicle 310 to output the information related to the destination. The electronic device 320 may transmit the information related to the destination to the mobile terminal 340 connected to the electronic device 320 so that the mobile terminal 340 may output the information related to the destination.

According to various embodiments of the present disclosure, the external server 330 may transmit information related to a destination to the mobile terminal 340 connected to the electronic device 320. The mobile terminal 340 receiving the information related to the destination may include a mobile terminal connected to the electronic device 320 through various communication means or a mobile terminal not connected directly to the electronic device 320 and having the same account information as the account information stored by the external server 330.

The mobile terminal 340 may receive the information related to the destination transmitted by the external server 330 or the electronic device 320 and may output the information related to the destination.

According to various embodiments of the present disclosure, the mobile terminal 340 may output information related to a destination in various forms such as a voice, a text, and an image.

Referring to FIG. 5A, the mobile terminal 340 capable of supporting a voice secretary application may output the information related to the destination requested by a user's voice by means of a text or a voice. Although not shown in FIG. 5A, the mobile terminal 340 may output the information related to the destination (requested in various forms such as a user's touch input, which is not a voice, etc.) to the mobile terminal 340, by means of a text or a voice.

For example, a user of the mobile terminal 340 may request information on an estimated time required until the user arrives at a destination (e.g., “L tower”) using a voice command. The mobile terminal 340 may retrieve information related to the destination from the external server 330 or the electronic device 320, and output the retrieved information in various forms. The information related to the destination may include an estimated time to arrival at the destination, an estimated time to park the vehicle, indication of a location of an available parking space, and the like.

According to various embodiments of the present disclosure, when the mobile terminal 340 provides a navigation service, the mobile terminal 340 may be operationally coupled with the navigation service and provide information related to a destination. While displaying a screen related to the navigation service, the mobile terminal 340 may output the information related to the destination through a display in various forms, such as a pop-up message, a multi-window, a snap window or the like, or using a voice.

Referring to FIG. 5B, a screen related to the navigation service may be displayed on a display 510 installed in the vehicle 310 for providing navigational service. The user may search for and set a destination using the display 510.

According to various embodiments of the present disclosure, in response to detecting that the destination is set, or arrival at the destination, the vehicle 310 may receive the information related to the destination from the electronic device 320 electrically connected to the vehicle 310, and/or the external server 330 which is connected to the vehicle 310 through various communication means, and/or the mobile terminal 340.

Referring to FIG. 5B, the in-vehicle display 510 may display information 525 related to the destination. Information 525 related to the destination may include indicators of traffic congestion, an estimated time to park the vehicle at the destination, and the like.

An electronic device according to various embodiments of the present disclosure may include: a wireless communication circuit; a processor operatively connected to the communication circuit; and a memory operatively connected to the processor, wherein when executed, the memory may store the following instructions allowing the processor to: detect that a vehicle arrives at a destination of a navigation service; request the vehicle for operation data after the detection; receive the operation date from the vehicle until a start of the vehicle is off; and transmit at least a part of the data to an external server through the wireless communication circuit.

In an electronic device according to various embodiments of the present disclosure, the detecting that the vehicle arrives at the destination may include receiving a signal from outside the electronic device, and the signal indicates that the vehicle arrives at the destination of the navigation service.

According to various embodiments of the present disclosure, an electronic device may further include a connector connected to the vehicle, wherein the memory further may include an instruction allowing the processor to receive the operation data through the connector.

According to various embodiments of the present disclosure, an electronic device may further include an on-board diagnostic (OBD) device.

According to various embodiments of the present disclosure, the memory of an electronic device may further include an instruction allowing the processor to provide the navigation service.

According to various embodiments of the present disclosure, the memory of an electronic device may further include an instruction to transmit at least a part of the operation data to the external server through the wireless communication circuit, in response to the arrival of the vehicle at a predetermined location.

According to various embodiments of the present disclosure, the memory of an electronic device may further include an instruction to confirm whether the start of the vehicle is an on state on considering at least a part of RPM information of the engine of the vehicle and operation information of the transmission of the vehicle, which are included in the operation data.

According to various embodiments of the present disclosure, the memory of an electronic device may further include an instruction to receive information related to the destination from the external server and transmit the information related to the destination to the vehicle.

According to various embodiments of the present disclosure, the memory of an electronic device may further include an instruction to confirm whether the navigation service is terminated in response to confirming that the start of the vehicle is not off; and control the vehicle to restart the navigation service using the information related to the destination when the navigation service is terminated.

According to various embodiments of the present disclosure, the memory of an electronic device may further include instructions to: confirm a distance between location information collected by a sensor of the electronic device and the destination; determine whether the vehicle is adjacent to the destination based on the confirmed distance; and provide information related to the destination in response to the determining that the vehicle is adjacent to the destination.

In the electronic device according to various embodiments of the present disclosure, the operation data of the vehicle may include time information when the vehicle arrives at the destination and time information when the operation of the vehicle engine is terminated.

In the electronic device according to various embodiments of the present disclosure, the information related to the destination may include the congestion information of the destination based on and generated from the time information when the vehicle arrives at the destination and the time information when the operation of the engine of the vehicle is terminated.

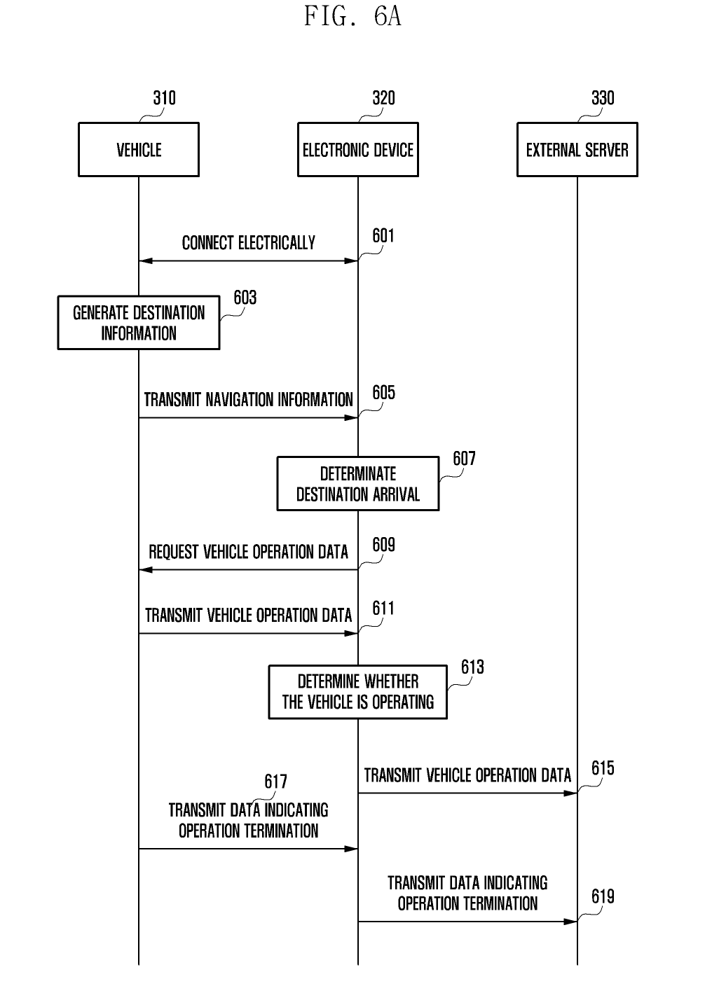

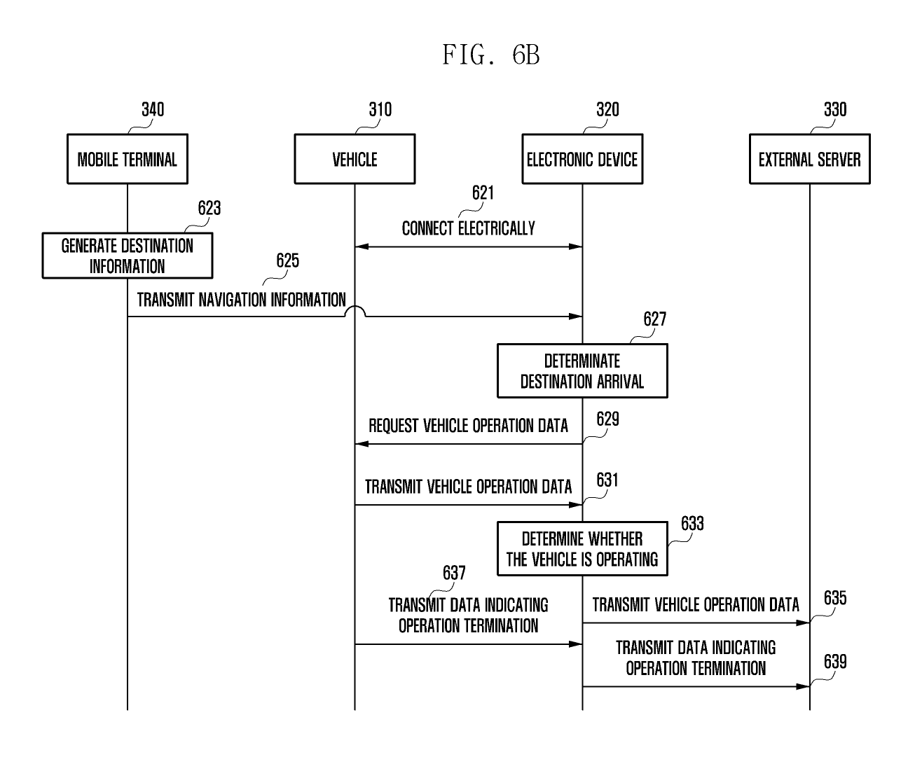

FIG. 6A is an operational flowchart illustrating interrelational processes between the electronic device, external server, and vehicle in a method for operating an electronic device according to various embodiments of the present disclosure.

FIG. 6A assumes that the vehicle (e.g., the vehicle 310 in FIG. 3) provides a navigation service providing a route to a destination set by a user.

Referring to FIG. 6A, in operation 601, the electronic device 320 according to various embodiments of the present disclosure may be electrically connected to the vehicle 310. In some embodiments, the vehicle 310 may be implemented as performing the operations performed by the electronic device 320, in which case operation 601 may be omitted.

In operation 603, the vehicle 310 may generate destination information. The destination information may be generated from an application supporting the navigation service provided by the vehicle 310. The vehicle 310 may prompt a user to input the destination using one or more various types of input (e.g., a voice input, a touch input through a display displaying a navigation service, a gesture input through a display displaying a navigation service, etc.). The vehicle 310 may generate the destination information including the destination location information (e.g., GPS coordinates of the destination, the destination address information, etc.) input by the user.

In operation 605, the vehicle 310 may transmit navigation information including the destination information to the electronic device 320. The navigation information may include various information such as the destination information (such as or including the destination generated from the operation 603), a departure location, route information to the destination, detection of arrival at the destination, and the like.

In operation 607, the electronic device 320 may determine whether the vehicle 310 has arrived at the destination.

According to various embodiments of the present disclosure, the electronic device 320 may receive the destination location information from the navigation information received from the operation 605, compare the distance between the current location of the electronic device 320 and the destination location, and determine the arrival of the vehicle at the destination, when the distance is less than or equal to a preset distance.

According to various embodiments of the present disclosure, the electronic device 320 may detect that the vehicle arrives at the destination of the navigation service in response to receiving data indicating the termination of the navigation service. The navigation service may be automatically terminated when the vehicle arrives at the destination or is adjacent to the destination. Accordingly, the electronic device 320 may detect that the vehicle arrives at the destination in response to receiving the data indicating that the navigation service is terminated.

According to various embodiments of the present disclosure, the electronic device 320 may determine that the vehicle 310 arrives at the destination when the display of the navigation service includes the information indicating that the vehicle 310 arrives at the destination.

In operation 609, the electronic device 320 may request the operation data of the vehicle 310.

According to various embodiments of the present disclosure, the electronic device 320 may request the operation data of the vehicle 310 in response to detecting that the vehicle 310 arrived at the destination.

According to various embodiments of the present disclosure, the operation data of the vehicle 310 may include whether the vehicle 310 is running or inactive, the RPMs of the engine, the information pertinent to the transmission of the vehicle 310 (e.g., like a present drive gear), fuel consumption or “MPG”, fuel quantity or level, etc.

In operation 611, the vehicle 310 may generate the operation data of the vehicle 310 and transmit the operation data of the vehicle 310 to the electronic device 320.

In operation 613, the electronic device 320 may determine whether the vehicle 310 is operating based on the operation data of the vehicle 310.

For example, the electronic device 320 may confirm engine RPMs included in the operation data of the vehicle 310, and determine whether the vehicle 310 is operating based on the RPMs of the engine. When the vehicle 310 is shut off, since the engine is not running, the RPMs may be confirmed to have a value of zero. When the vehicle 310 is running, since the engine is rotating, the RPMs may be confirmed to be higher than zero.

For another example, the electronic device 320 may confirm the operation information of the transmission of the vehicle 310 and determine whether the vehicle 310 is operating based on the operation information of the transmission. To park and shut off a drivers typically shift the vehicle 310 to a “park” position (e.g., by setting the shift lever to “P”). The processor 323 may determine whether to terminate the operation of the vehicle 310 based at least in part on the operation information indicating the transmission gear is set to “park.”

For another example, the electronic device 320 may confirm the speed information of the vehicle 310 (e.g., “zero”), the location information of the vehicle 310 (e.g., “in a parking spot”), and the like, and determine whether the vehicle 310 is operating based on the confirmed information.

According to various embodiments of the present disclosure, the electronic device 320 may continuously request the vehicle 310 for the operation data of the vehicle 310 and the vehicle 310 may transmit the operation data of the vehicle 310 in response to the request of the operation data transmitted by the electronic device 320.

In operation 615, the electronic device 320 may transmit the operation data of the vehicle 310 to the external server 330.

According to various embodiments of the present disclosure, the electronic device 320 may transmit the information collected by various sensors (e.g., an air pressure sensor, a GPS sensor, etc.) installed in the electronic device 320 to the external server 330 together with the operation data of the vehicle 310. For example, when the electronic device 320 includes an air pressure sensor, the electronic device 320 may confirm that the altitude at which the vehicle 310 is currently located, the floor on which the vehicle 310 is currently located in the building where the vehicle comes in, or the like based on the data transmitted by the air pressure sensor. The collected information that the electronic device 320 transmits to the external server 330 may be used to generate information related to the destination together with the operation data of the vehicle 310.

In operation 617, the vehicle 310 may detect that the operation is terminated and may transmit data indicating the operation is terminated to the electronic device 320. According to various embodiments of the disclosure, the vehicle 310 may transmit the data, indicating the termination of the operation, to the electronic device 320 in response to the user's input terminating the engine.

According to various embodiments of the present disclosure, the vehicle 310 may monitor speed and operation distance of the vehicle 310, and may transmit data indicating the termination of the operation to the electronic device 320 in response to determining that the speed and operation distance of the vehicle 310 is less than or equal to a pre-set value.

In operation 619, the electronic device 320 may transmit data to the external server 330 indicating the termination of the operation.

FIG. 6B is an operational flowchart illustrating relations among an electronic device (e.g., the electronic device 320 in FIG. 3), a mobile terminal (e.g., the mobile terminal 340 in FIG. 3), an external server (e.g., the external server 330 in FIG. 3), and a vehicle (e.g., the vehicle 310 in FIG. 3) in a method for operating an electronic device according to various embodiments of the present disclosure.

FIG. 6B assumes that the mobile terminal 340 provides a navigation service providing a route to a destination set by the user.

Referring to FIG. 6B, in operation 621, an electronic device 320 according to various embodiments of the present disclosure may be electrically connected to the vehicle 310. When the vehicle 310 is implemented such that it performs the operations of the electronic device 320, operation 601 may be omitted.

In operation 623, the mobile terminal 340 may generate the destination information. The destination information may be generated from an application supporting the navigation service provided by the mobile terminal 340. The mobile terminal 340 may prompt a user to input the destination using various types of input (e.g., a voice input, a touch input through a display displaying a navigation service, a gesture input through a display displaying a navigation service, etc.). The mobile terminal 340 may generate the destination information including the destination location information (e.g., GPS coordinates of the destination, the destination address information, etc.) input by the user.

In operation 625, the mobile terminal 340 may transmit navigation information including the destination information to the electronic device 320. The navigation information may include various information such as a destination generated from operation 623, a departure location, route information navigating to the destination, detection of arrival at the destination, and the like.

In operation 627, the electronic device 320 may determine whether the vehicle 310 has arrived at the destination.

According to various embodiments of the present disclosure, the electronic device 320 may receive the destination location information from the navigation information received from the operation 625, compare the distance between the current location of the electronic device 320 and the destination location, and determine that the vehicle has arrived at the destination when the distance is less than or equal to a preset distance.

According to various embodiments of the present disclosure, the electronic device 320 may detect that the vehicle has arrived at the destination of the navigation service in response to receiving data indicating the termination of the navigation service. The navigation service may be automatically terminated when the vehicle arrives at the destination or is adjacent to the destination. Accordingly, the electronic device 320 may detect that the vehicle has arrived at the destination in response to receiving data indicating that the navigation service is terminated.

According to various embodiments of the present disclosure, the electronic device 320 may determine that the mobile terminal 340 arrives at the destination when the display of the navigation service includes the information indicating that the mobile terminal 340 arrives at the destination.

In operation 629, the electronic device 320 may request the operation data of the vehicle 310.

According to various embodiments of the present disclosure, the electronic device 320 may request the operation data of the vehicle 310 in response to detecting that the vehicle 310 arrived at the destination.

According to various embodiments of the present disclosure, the operation data of the vehicle 310 may include whether the vehicle 310 is running or shut off, engine RPMs, transmission information such as a drive gear, present fuel consumption or “MPG”, a quantity of remaining fuel, etc.

In operation 631, the vehicle 310 may generate the operation data of the vehicle 310 and transmit the operation data of the vehicle 310 to the electronic device 320.

In operation 633, the electronic device 320 may determine whether the vehicle is operating based on the operation data of the vehicle 310.

For example, the electronic device 320 may confirm a present level of engine RPMs included in the operation data of the vehicle 310 and determine whether the vehicle 310 is operating based on the detected RPMs. When the vehicle 310 terminates the operation, since the start of the engine is off, the RPM may be confirmed to be zero. When the vehicle 310 continues the operation, since the start of the engine is on state, the RPM may be confirmed to be other than zero.

For another example, the electronic device 320 may confirm the operation information of the transmission of the vehicle 310 and determine whether the vehicle 310 is operating based on the operation information of the transmission. To park the vehicle 310 before terminating the operation of the vehicle 310, the user may control the transmission using the shift lever of the vehicle 310 (for example, the parking may be completed by setting the shift lever to P and the shift lever may be operated (repetition of D, N, R) for parking). The processor 323 may determine whether to terminate the operation of the vehicle 310 based on the operation information of the transmission.

For another example, the electronic device 320 may confirm the speed information of the vehicle 310, the location information of the vehicle, and the like, and determine whether the vehicle 310 is operating based on the confirmed information. According to various embodiments of the present disclosure, the electronic device 320 may continuously request the vehicle 310 for the operation data of the vehicle 310 and the vehicle 310 may transmit the operation data of the vehicle 310 in response to the request of the operation data transmitted by the electronic device 320.

According to various embodiments of the present disclosure, the electronic device 320 may transmit the information collected by various sensors (e.g., an air pressure sensor, a GPS sensor, etc.) installed in the electronic device 320 to the external server 330 together with the operation data of the vehicle 310. For example, when the electronic device 320 include an air pressure sensor, the electronic device 320 may confirm that the altitude at which the vehicle 310 is currently located, the floor on which the vehicle 310 is currently located in the building where the vehicle comes in, or the like based on the data transmitted by the air pressure sensor. The collected information that the electronic device 320 transmits to the external server 330 may be used to generate information related to the destination together with the operation data of the vehicle 310.

In operation 637, the vehicle 310 may detect that the operation is terminated and may transmit data, indicating the operation is terminated, to the electronic device 320.

According to various embodiments of the disclosure, the vehicle 310 may transmit the data, indicating the termination of the operation, to the electronic device 320 in response to the user's input terminating the engine.

According to various embodiments of the present disclosure, the vehicle 310 may monitor speed and operation distance of the vehicle 310, and may transmit data indicating the termination of the operation to the electronic device 320 in response to determining that the speed and operation distance of the vehicle 310 is less than or equal to a pre-set value. In operation 639, the electronic device 320 may transmit data to the external server 330 indicating the termination of the operation.

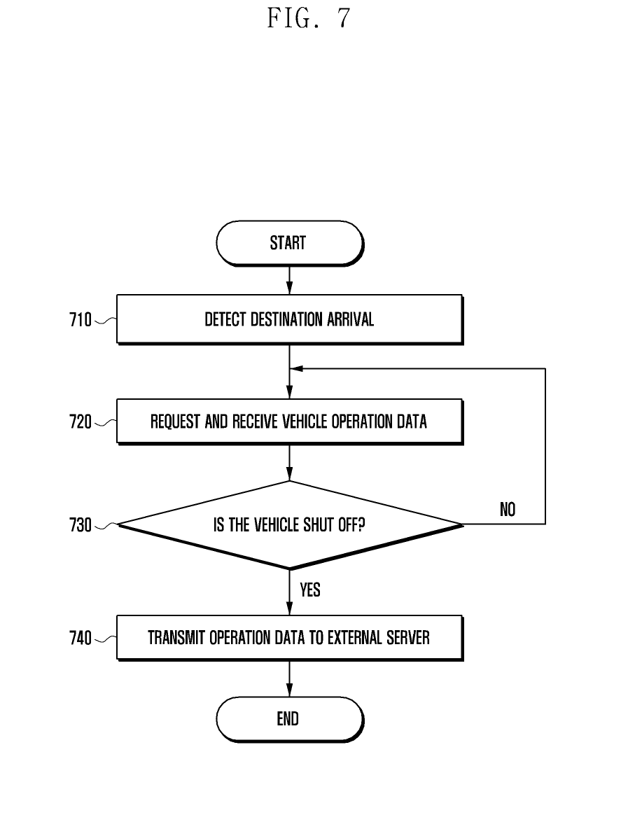

FIG. 7 is an operational flowchart illustrating a method for operating an electronic device according to various embodiments of the present disclosure. Referring to FIG. 7, in operation 710, a processor (e.g., the processor 323 in FIG. 4) of an electronic device (e.g., the electronic device 320 in FIG. 3) may detect that a vehicle (e.g., the vehicle 310 in FIG. 3) has arrived at the set destination.

According to various embodiments of the present disclosure, the processor 323 may determine that the vehicle has arrived at the destination based on destination information received by the electronic device 320, a current location detected by the position sensor installed in the electronic device 320, or a current location transmitted by the vehicle 310 or the mobile terminal 340.

According to various embodiments of the present disclosure, the processor 323 may detect that the vehicle arrives at the destination of the navigation service in response to receiving data indicating the termination of the navigation service. The navigation service may be automatically terminated when the vehicle arrives at the destination or the vehicle is adjacent to the destination. Accordingly, the processor 323 may detect that the vehicle arrives at the destination based on receiving the data indicating that the navigation service is terminated.

In the operation 710, the processor 323 may request vehicle operation data from the vehicle 310, and thereby receive operation data from the vehicle 310 in response to detecting the vehicle 310 has arrived at the destination.

According to various embodiments of the present disclosure, the operation data of the vehicle 310 may include various information related to the vehicle 310 such as information indicating whether the vehicle 310 is running, engine RPMs, the operation information of the transmission of the vehicle 310 such as a present drive gear, a present fuel consumption, a quantity of remaining fuel, etc.

In operation 730, processor 323 may determine whether the vehicle is deactivated or running based on the operation data of vehicle 310.

According to various embodiments of the present disclosure, the processor 323 may determine whether the vehicle 310 is shut off or otherwise deactivated on considering various information such as a present speed, engine RPMs, or a present drive gear of the transmission, this information being included in the operation data of the vehicle 310.

In response to determining that the start of the vehicle 310 is running, the processor 323 may return to the operation 720 to request the operation data of the vehicle 310 and receive the same.

In operation 740, in response to determining that the vehicle 310 is shut off, the processor 323 may transmit the operation data of the vehicle 310 to an external server (e.g., the external server 330 in FIG. 3).

According to various embodiments of the present disclosure, the processor 323 the processor 323 may transmit information collected by various sensors (e.g., an air pressure sensor, a GPS sensor, etc.) installed in the electronic device 320 to the external server 330 together with the operation data of the vehicle 310. For example, when the electronic device 320 includes an air pressure sensor, the electronic device 320 may confirm that an altitude at which the vehicle 310 is currently located or a floor on which the vehicle 310 is currently located in the building where the vehicle comes in, based on the data transmitted from the air pressure sensor. The collected information that the electronic device 320 transmits to the external server 330 may be used to generate information related to the destination together with the operation data of the vehicle 310.

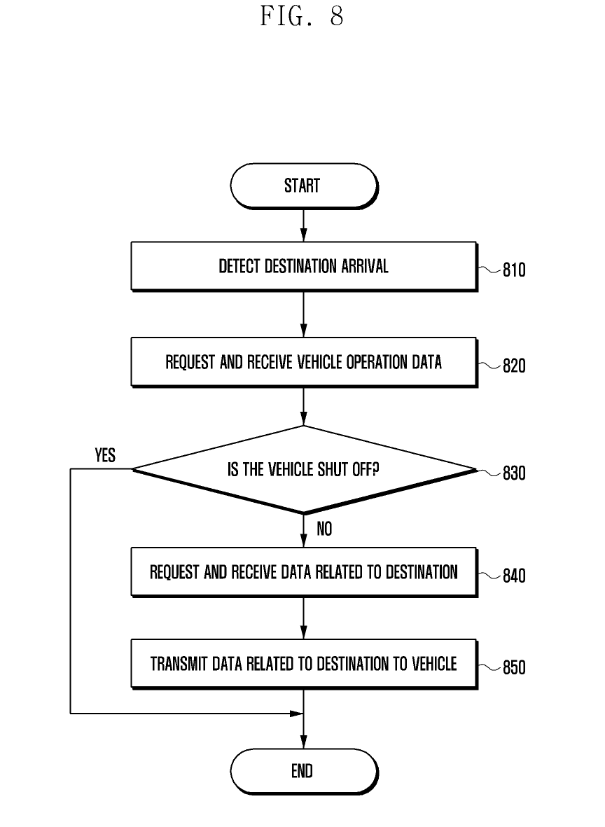

FIG. 8 is an operational flowchart illustrating a method for operating an electronic device according to another embodiment of the present disclosure.

Referring to FIG. 8, in operation 810, a processor (e.g., the processor 323 in FIG. 4) of an electronic device (e.g., the electronic device 320 in FIG. 3) may detect that a vehicle has arrived at a destination.

In operation 820, the processor 323 may request operation data of the vehicle (e.g., the vehicle 310 in FIG. 3) and receive the operation data from the vehicle 310.

In operation 830, the processor 323 may determine whether the vehicle 310 is deactivated or otherwise shut off based on the operation data of the vehicle 310.

In operation 840, the processor 323 may request and receive data related to the destination in response to determining that the start of the vehicle 310 is running.

According to various embodiments of the present disclosure, the processor 323 may request the external server 330 connected to electronic device 320 through various communication means or the mobile terminal 340 for the data related to a destination

According to various embodiments of the disclosure, the information related to the destination may include traffic congestion based on the traffic volume at the destination, available parking in a lot near the destination, and the like. The external server 330 may generate and transmit the information related to the destination using the operation data of the vehicle 310 transmitted by various electronic devices connected to the external server 330, including the electronic device 320, and the sensor data transmitted by the electronic device 320.

According to various embodiments of the present disclosure, the congestion information may be generated based on the difference between the time information of arrival of the vehicle at the destination and the time information when the start of the vehicle is off. The external server 330 according to the various embodiments of the present disclosure may generate the congestion information based on the difference between the time information of arrival of the vehicle at the destination transmitted by the various electronic devices connected to the external server and the time information when the start of the vehicle is off.

According to various embodiments of the present disclosure, the mobile terminal 340 may receive data related to the destination from the external server 330 in response to a request of the electronic device 320 for the data related to the destination, and may transmit the data related to the destination to the electronic device 320.

According to various embodiments of the present disclosure, the external server 330 may transmit the data related to the destination to the electronic device 320 in response to a request of the electronic device 320 for the data related to the destination.

A method for operating an electronic device according to various embodiments of the present disclosure may include the following operations executed by a processor: detecting that a vehicle arrives at a destination of a navigation service; requesting the vehicle for operation data after the detection; receiving the operation data from the vehicle until a start of the vehicle is off; and transmitting at least a part of the data to an external server through a wireless communication circuit.

In a method for operating an electronic device according to various embodiments of the present disclosure, the detecting that the vehicle arrives at the destination may include receiving a signal from outside the electronic device, and the signal indicates the arrival of the vehicle at the destination of the navigation service.

A method for operating an electronic device according to various embodiments of the present disclosure may further include transmitting at least a part of the operation data to the external server through the wireless communication circuit, in response to the arrival of the vehicle at a predetermined location.

In a method for operating an electronic device according to various embodiments of the present disclosure, confirming whether the start of the vehicle is an on state may be made on considering at least a part of RPM information of an engine and operation information of a vehicle transmission, which are included in the operation data.

A method for operating an electronic device according to various embodiments of the present disclosure may further include: confirming whether the navigation service is terminated in response to confirming that the start of the vehicle is an on state; and controlling the navigation service to be restarted using the information related to the destination when the navigation service is terminated.

A method for operating an electronic device according to various embodiments of the present disclosure may further include: confirming a distance between location information collected by a sensor of the electronic device and the destination; determining whether the vehicle is adjacent to the destination based on the confirmed distance; and requesting the external server for information related to the destination in response to determining that the vehicle is adjacent to the destination.

In a method for operating an electronic device according to various embodiments of the present disclosure, the operation data of the vehicle may include time information when the vehicle arrives at the destination and time information when the operation of the engine is terminated.

In the method for operating an electronic device according to various embodiments of the present disclosure, the information related to the destination may include congestion information of the destination based on and generated from the time information of arrival of the vehicle at the destination and the time information of the termination of the engine operation.

The above-discussed method is described herein with reference to flowchart illustrations, methods, and computer program products according to example embodiments of the present disclosure. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that are executed on the computer or other programmable apparatus provide operations for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Certain example aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a ROM, a RAM, compact disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various example embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various example embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

Aspects of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device communicatively coupled to a vehicle, comprising:
a wireless communication circuit;
a sensor;
at least one processor operatively coupled to the wireless communication circuit; and
a memory operatively coupled to the at least one processor, wherein the memory stores instructions executable by the at least one processor to cause the electronic device to:
detect by the sensor whether the vehicle arrives at a destination location,
when the vehicle arrives at the destination location, transmit to the vehicle a request for operation data of the vehicle,
after receiving the operation data from the vehicle, detect based on the received operation data whether the vehicle is deactivated, and
transmit at least a part of the data to an external server using the wireless communication circuit.

2. The electronic device of claim 1, wherein detecting whether the vehicle arrives at the destination location further includes:
receiving an external signal indicating arrival of the vehicle at the destination location.

3. The electronic device of claim 1, wherein the vehicle includes a connector, and the instructions executable by the at least one processor further cause the electronic device to:
receive the operation data through the connector.

4. The electronic device of claim 3, further comprising:
an on-board diagnostic (OBD) device.

5. The electronic device of claim 1, wherein the instructions are further executable by the at least one processor to cause the electronic device to: provide a navigation service in which the destination location is set.

6. The electronic device of claim 1, wherein the instructions are further executable by the at least one processor to cause the electronic device to:
transmit at least a part of the operation data to the external server through the wireless communication circuit, in response to detecting arrival of the vehicle at the destination location.

7. The electronic device of claim 1, wherein the instructions are further executable by the at least one processor to:
confirm whether the vehicle is running based on the operation data, including information indicating rotations-per-minute (RPM) of an engine of the vehicle, and information indicating a present gear of a transmission of the vehicle.

8. The electronic device of claim 1, wherein the instructions are further executable by the at least one processor to:
receive information related to the destination location from the external server and transmit the received information to the vehicle.

9. The electronic device of claim 1, wherein the instructions are further executable by the at least one processor to:
confirm whether a navigation service is terminated in response to confirming that the vehicle is running; and
when the navigation service is terminated, control the vehicle to restart the navigation service using information related to the destination location.

10. The electronic device of claim 1, wherein the instructions are further executable by the at least one processor to:
confirm a distance between a present location detected by the sensor of the electronic device and the destination location;
determine whether the vehicle is within a threshold distance of the destination location based on the confirmed distance; and
provide information related to the destination location in response to determining that the vehicle is within the threshold distance of the destination location.

11. The electronic device of claim 8, wherein the operation data of the vehicle includes a first time at which the vehicle arrives at the destination, and a second time when operation of an engine of the vehicle is terminated.

12. The electronic device of claim 11, wherein the information related to the destination location includes traffic congestion at the destination location at the first time in which the vehicle arrives at the destination location and the second time when the operation of the vehicle engine is terminated.

13. A method in an electronic device communicatively coupled to a vehicle, comprising:
detecting by a sensor whether the vehicle arrives at a destination location;
when the vehicle arrives at the destination location, transmitting to the vehicle a request for operation data of the vehicle;
after receiving the operation data from the vehicle, detecting based on the received operation data whether the vehicle is deactivated, and
transmitting at least a part of the data to an external server using a wireless communication circuit.

14. The method of claim 13, wherein detecting whether the vehicle arrives at the destination location further includes:
receiving an external signal indicating arrival of the vehicle at the destination location.

15. The method of claim 13, further comprising:
transmitting at least a part of the operation data to the external server through the wireless communication circuit in response to detecting arrival of the vehicle at the destination location.

16. The method of claim 15, further comprising:
confirming whether the vehicle is running based on the operation data, including information indicating rotations-per-minute (RPM) of an engine of the vehicle, and information indicating a present gear of a transmission of the vehicle.

17. The method of claim 15, further comprising:
confirming whether a navigation service is terminated in response to confirming that the vehicle is running; and
when the navigation service is terminated, controlling the vehicle to restart the navigation service using information related to the destination location.

18. The method of claim 15, further comprising:
confirming a distance between the location collected by the sensor of the electronic device and the destination;
determining whether the vehicle is adjacent to the destination based on the confirmed distance; and
requesting the external server for information related to the destination location in response to determining that the vehicle is adjacent to the destination.

19. The method of claim 15, wherein the operation data of the vehicle includes a first time at which the vehicle arrives at the destination location, and a second time when operation of an engine of the vehicle is terminated.

20. The method of claim 19, wherein information related to the destination location includes traffic congestion at the destination location at the first time in which the vehicle arrives at the destination location and the second time when the operation of the vehicle engine is terminated.
